(19) United States
(12) Patent Application Publication
(10) Pub. No.: US 2015/0083589 A1
(43) Pub. Date: Mar. 26, 2015

(54) BIO SENSING DEVICE

(71) Applicants: Jin-Woo Lee, Chungcheongnam-do (KR); Jae-Kyu Choi, Chungcheongnam-do (KR)

(72) Inventors: Jin-Woo Lee, Chungcheongnam-do (KR); Jae-Kyu Choi, Chungcheongnam-do (KR)

(73) Assignee: CERAGEMMEDISYS INC., Gyeonggi-do (KR)

(21) Appl. No.: 14/382,563

(22) PCT Filed: Mar. 31, 2012
(86) PCT No.: PCT/KR2012/002432

§ 371 Date: Sep. 3, 2014

(51) Int. Cl. G01N 27/327

(52) U.S. Cl. CPC G01N 27/327
USPC 204/403.01

(57) ABSTRACT

The present invention relates to a bio sensing device having a reaction part and a measuring device which are integrated therein. The bio sensing device includes: a main substrate, a reaction part, a signal processing part, a screen display part, and a housing. The reaction part includes a reaction reagent to react in an oxidation-reduction reaction with an analysis target material and a reaction electrode to generate an analogue electrical signal by causing the oxidation-reduction reaction, and is located at an end of the main substrate. The signal processing part is located on a first side of the main substrate and processes the analogue electrical signal. The screen display part displays a processing result of the signal processing part. The housing houses the main substrate. The screen display part is three-dimensionally disposed over the signal processing part, and a space for mounting a lancet is formed in the housing.

### TECHNICAL FIELD

The present invention relates to a bio sensing device, and more particularly, to a bio sensing device having a biosensor and a measuring device which are integrated therein.

### BACKGROUND ART

Biosensors are measuring instruments that examine the properties of a target substance using functions of an organism. These biosensors are excellent in sensitivity and reaction specificity because the biosensors use a biomaterial as a detecting element. The biosensors are divided into enzyme assay biosensors and immunoassay biosensors according to an analysis reaction, and into optical biosensors and electrochemical biosensors according to a method of quantitatively analyzing a target substance within a bio-sample. The enzyme assay biosensors are designed to use a specific reaction between an enzyme and a substrate and a specific reaction between an enzyme and an enzyme inhibitor, and the immunoassay biosensors are designed to a specific reaction between an antigen and an antibody. The optical biosensors are designed to measure a concentration of a target material by measuring transmittance, absorbance, or alteration in wavelength, and have been most generally used.

Generally, in order to check a value measured by a biosensor, the biosensor should be inserted into a measuring device. When the biosensor is inserted into the measuring device, the measuring device senses the insertion and analyzes a concentration of a target material according to an electrochemical method or the like. At this time, because of contact impedance caused by a connection node (for example, socket, connector or the like) to which the biosensor and the measuring device are connected, an error may occur in the result value measured by the biosensor. Furthermore, a sensing error may occur in the connection between the measuring device and the biosensor. For example, when measuring devices are produced in large quantities, a connection node of each measuring device may have a different impedance value. When an electrode or connector of the biosensor in an imperfect state is connected to the measuring device, the impedance may be varied. In such a state, it is impossible to guarantee the precision and reproducibility of measured values.

Furthermore, in the conventional bio sensing device where the biosensor is inserted into the measuring device, the biosensor, the measuring device, and a lancet device should be separately provided, which makes it inconvenient to carry and use the bio sensing device.

### DISCLOSURE

### Technical Problem

An embodiment of the present invention is directed to a bio sensing device capable of increasing precision and reproducibility of measured values.

Another embodiment of the present invention is directed to a bio sensing device which is easy to carry and use.

### Technical Solution

In accordance with an embodiment of the present invention, a bio sensing device includes: a main substrate; a reaction part comprising a reaction reagent to react in an oxidation-reduction reaction with an analysis target material and a reaction electrode to generate an analogue electrical signal by causing the oxidation-reduction reaction, and located at an end of the main substrate; a signal processing part located on a first side of the main substrate and processing the analogue electrical signal; a screen display part displaying a processing result of the signal processing part; and a housing to house the main substrate. The screen display part is three-dimensionally disposed over the signal processing part, and a space for mounting a lancet is formed in the housing.

In accordance with another embodiment of the present invention, a bio sensing device comprising: a main substrate having a protruding end; a reaction part comprising a reaction reagent to react in an oxygen-reduction reaction with an analysis target material and a reaction electrode to generate an analogue electrical signal by causing the oxygen-reduction reaction, and located at the end of the main substrate; a signal processing part located on a first side of the main substrate and processing the analogue electrical signal; a screen display part displaying a processing result of the signal processing part. The screen display part is disposed on a second side of the main substrate and opposite to the first side, and a space for mounting a lancet is formed opposite to the end of the main substrate.

### Advantageous Effects

According to the embodiments of the present invention, the bio sensing device has a structure in which a measuring device is electrically connected to a bio sensor without a connection node such as a connector or socket. Therefore, since there is no impedance caused by the connection between the reaction part and the measuring device through a connection node, signal distortion by contact impedance does not occur, which makes it possible to increase the precision of measurement. Furthermore, an electrode for detecting sensor insertion, which is required when the biosensor is connected to the measuring device, and an electrode for detecting the type of an analysis target material are not necessary. Therefore, a detection error does not occur. Accordingly, the bio sensing device may perform a bio-sending operation more reliably. Furthermore, since the biosensor and the lancet may be integrated with the measuring device, it is convenient to carry and use the bio sensing device. Furthermore, a complex switch is not used so as to be suitable for throwaway products, and a capillary tube is formed through the bracket. Therefore, it is possible to minimize the manufacturing cost.

### BRIEF DESCRIPTION OF THE DRAWINGS

FIG. 1 is a perspective view of a bio sensing device according to an embodiment of the present invention.

FIG. 2 is an exploded perspective view of FIG. 1.

FIG. 3 is a perspective view of main components of FIG. 2.

FIG. 4 is a perspective view illustrating a state where the main components of FIG. 3 are assembled.

FIG. 5 is a side perspective view of FIG. 4.

FIGS. 6 and 7 are perspective views illustrating a state where a bracket and a reaction part of FIG. 2 are coupled.

FIG. 8 is a detailed perspective view of the bracket of FIG. 2.

FIGS. 9 and 10 are perspective views illustrating a state that power supply is disconnected/connected.

FIGS. 11 to 13 are perspective views of bio sensing devices according to other embodiments of the present invention.

FIG. 14 is a perspective view of a bio sensing device according to another embodiment of the present invention.

FIGS. 15 to 24 are perspective views of bio sensing devices according to other embodiments of the present invention.

### BEST MODE FOR THE INVENTION

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. In the exemplary embodiments of the present invention, a case in which a concentration of blood sugar in the blood is measured by ampero-metry will be taken as an example for descriptions. However, it may be easily understood by those skill in the art that the present invention may be applied to all electrochemical bio-sensing technologies including the blood sugar measurement.

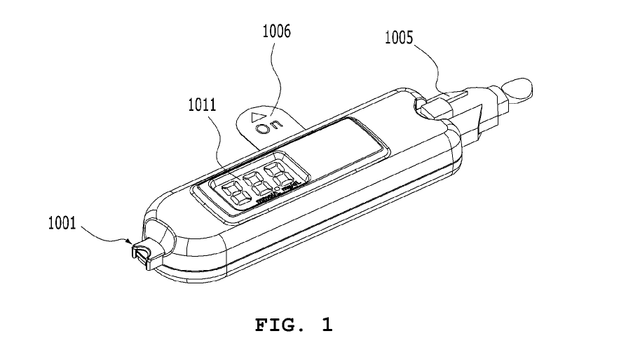

Referring to FIGS. 1 to 8, a bio sensing device according to an embodiment of the present invention will be described. The bio sensing device according to the embodiment of the present invention includes a reaction part 1001, a bracket 1002, a reaction unit 1003, a lancet mounting space 1004, a lancet 1005, a power supply breaker 1006, a main substrate 1007, a main substrate power pin 1008, a battery 1009, a battery terminal 1010, a screen display part 1011, an auxiliary substrate 1012, a signal processing part 1013, a temperature sensor 1014, a voice/sound output part (speaker, buzzer or the like) 1015, an upper housing 1016, and a lower housing 1017. As illustrated in the drawings, the bio sensing device according to the embodiment of the present invention is implemented by integrating a biosensor and a measuring device, and includes the lancet mounting space to attach/detach the lancet.

Referring to FIG. 1, a use example of the bio sensing device will be described as follows. First, a user pulls the power supply breaker 1006 out of the bio sensing device to change a power-off state to a power-on state. Then, the user takes the lancet 1005 out of the bio sensing device, and shoots a blood needle such that blood flows from his/her finger. Then, the user contacts a portion of the finger, from which blood flows, with the reaction part 1001, and checks his/her blood sugar level through the screen display part 1011 after a predetermined time passes. The bio sensing device having been used for checking the blood sugar level is discarded by the user.

The bio sensing device according to the embodiment of the present invention has the following main features. First, the bracket 1002 and the reaction unit 1003 constitute the reaction part 1001 having a reaction chamber structure, thereby improving a sample introduction function through a capillary action. Second, the power supply breaker 100 having a simple structure may be used to disconnect/connect the power supply of the battery. Therefore, the battery power waste may be prevented when the bio sensing device is not used, and the manufacturing cost may be reduced. Third, as the lancet mounting space 1004 is formed in the bio sensing device, the biosensor, the measuring device, and the lancet 1005 may be integrated to thereby increase the use convenience. Fourth, the screen display part 1011 is disposed three-dimensionally with respect to the signal processing part 1013 on the main substrate 1007, thereby preventing an increase in length and area of the bio sensing device by the lancet mounting space 1004.

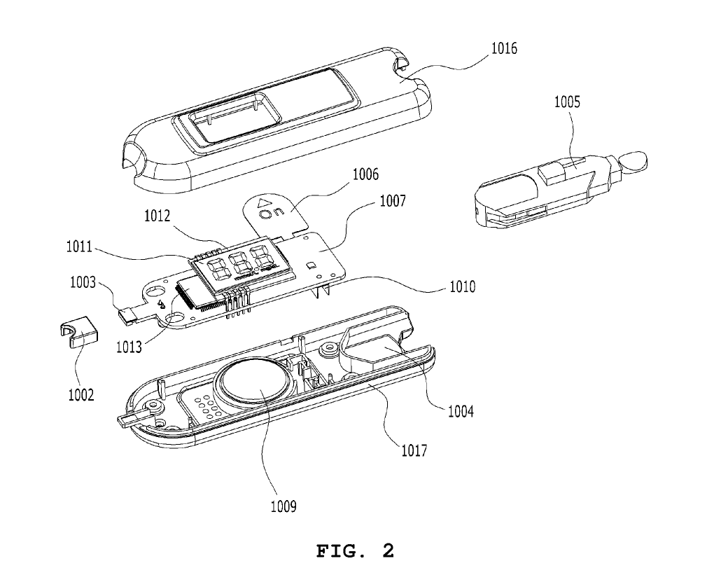

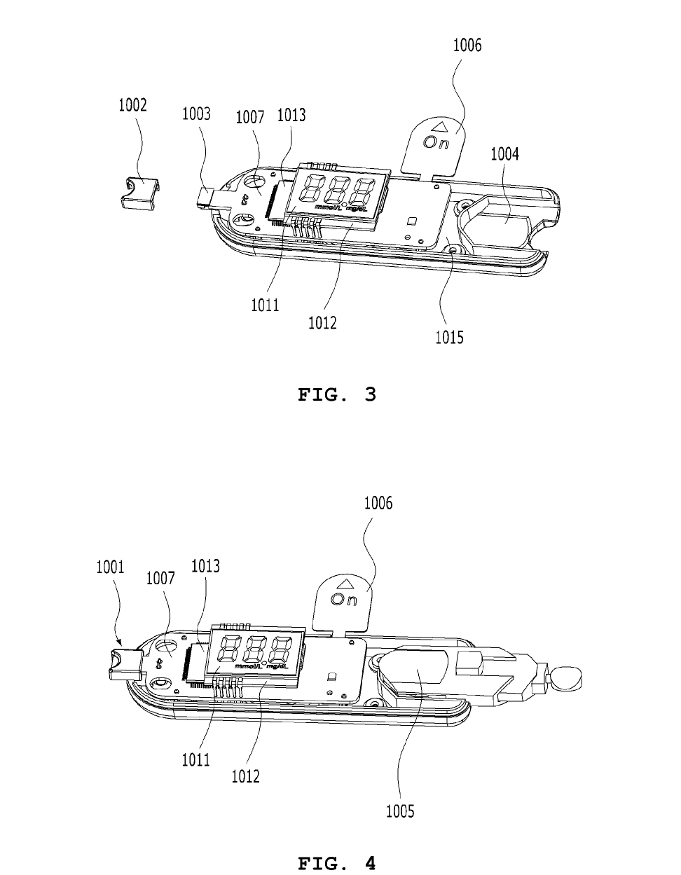

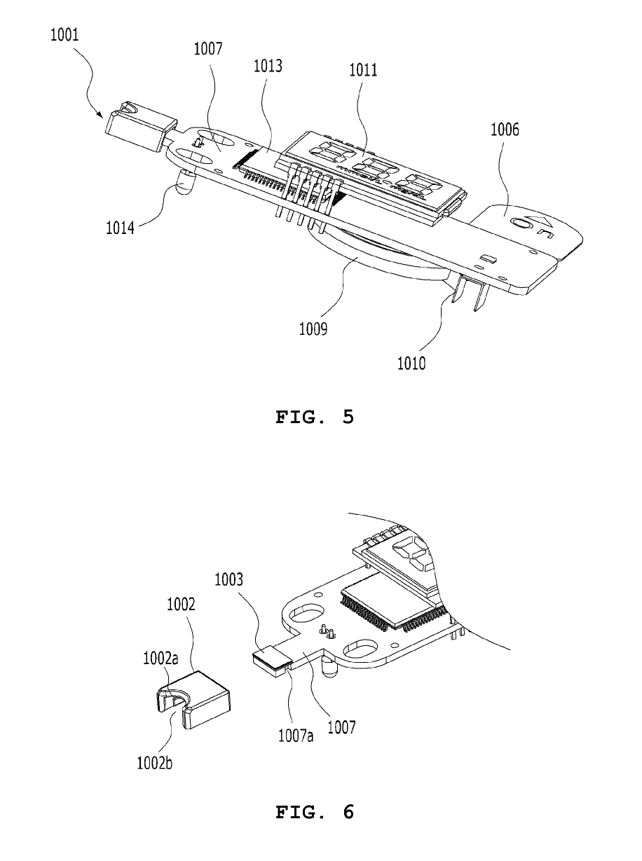

Hereafter, the components related to the above-described main features of the bio sensing device will be described in detail with reference to the accompanying drawings. FIG. 2 is an exploded perspective view of FIG. 1. FIG. 3 is a perspective view of main components of FIG. 2. FIG. 4 is a perspective view illustrating a state where the main components of FIG. 3 are assembled. FIG. 5 is a side perspective view of FIG. 4.

The upper housing 1016 and the lower housing 1017 serve as a case of the bio sensing device. A left end of the lower housing 1017 has a support surface for fixing the reaction part 1001, and a left end of the upper housing 1016 has a groove for exposure to the outside.

The signal processing part 1013 is disposed on the top surface of the main substrate 1007, and the reaction part 1001 consisting of the bracket 1002 and the reaction unit 1003 is disposed on an end of the top surface of the main substrate 1007. The reaction part 1013 formed on the end of the top surface of the main substrate 1007 includes a reaction electrode and a reaction reagent placed on the reaction electrode, and a conducting wire (not illustrated) for a signal transmission function is formed between the signal processing part 1013 and the reaction electrode of the reaction part 1003. The reaction electrode is not shown in the drawing because it is covered by the reaction reagent.

Referring to FIG. 5, the screen display part 1011 is three-dimensionally disposed over the signal processing part 1013 of the main substrate 1007. The screen display part 1011 is mounted on the top surface of the auxiliary substrate 1012, and a data/power pin of the auxiliary substrate 1012 is connected to the main substrate 1007. In this embodiment of the present invention, the screen display part 1011 and the auxiliary substrate 1012 are separately provided. However, it may be considered that the screen display part 1011 and the auxiliary substrate 1012 serve as one part for a display function.

The screen display part 1011 and the signal processing part 1013 may be disposed on the other surface of the main substrate 1007. In this case, a separate auxiliary substrate for disposing the screen display part 1011 in a three-dimensional manner with respect to the signal processing part 1013 is not necessary.

The main substrate 1007 may include the temperature sensor 1014 to provide temperature information which is used to perform temperature compensation related to a blood sugar level measured through the reaction part 1001. The temperature sensor 1014 may be disposed adjacent to the reaction part 1001 as illustrated in FIG. 5. The bio sensing device may include the voice/sound output part 1015 for diabetic patients who have a difficulty in perceiving a variety of information through the screen display part 1011 because of the failure of eyesight. The reaction part 1001 may be mounted on the main substrate 1007, and the reaction part 1001 and the signal processing part 1013 of the main substrate 1007 may be electrically connected through the conducting wire so as to be integrated with each other. In particular, the reaction electrode of the reaction part 1001 may be electrically connected to the conducting wire through wire bonding so as to be integrated with each other.

The reaction part 1001 may be formed on a separate substrate instead of the main substrate 1007. The separate substrate having the reaction part 1001 formed thereon may be electrically connected to the main substrate 1007 through a rigid/flexible printed circuit board bonding technology. Furthermore, the separate substrate having the reaction part 1001 formed thereon may be electrically connected to the main substrate 1007 through a heat seal so as to be integrated with each other.

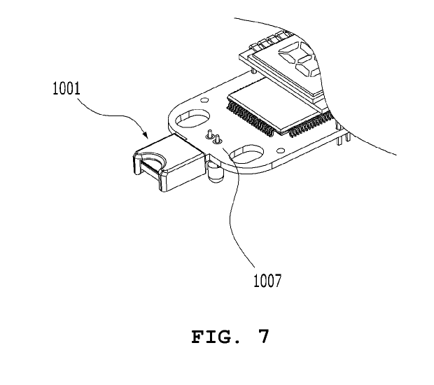

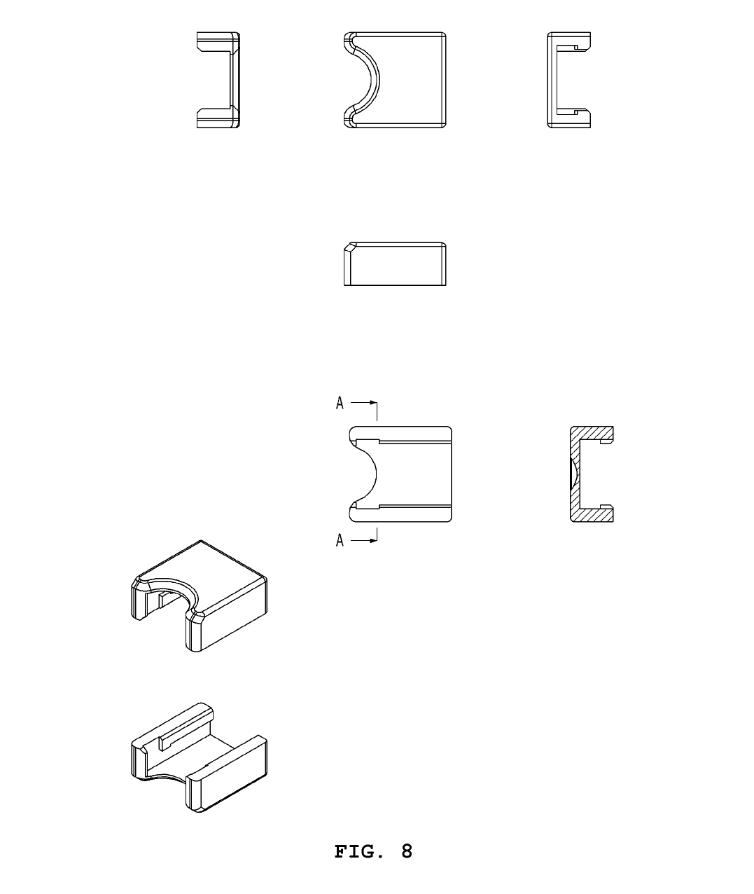

FIG. 6 illustrates a state before the bracket 1002 and the reaction unit 1003 constituting the reaction part 1001 are coupled (that is, assembled into a product). FIG. 7 illustrates a state after the bracket 1002 is coupled to the reaction part 1003. That is, the bracket 1002 is slid and coupled to the front end of the reaction part 1003. In this case, protrusions 1002a formed inside the bracket 1002 are caught in grooves 1007a formed in both sides of the main substrate 1007 under the reaction part 1003, thereby fixing the bracket 1002.

FIG. 8 is a detailed perspective view of the bracket 1002 of FIG. 2. As illustrated in FIGS. 6 and 8, the protrusions 1002a are formed inside the bracket 1002. The top of the bracket 1002, which is located over the reaction part 1003 according to the coupling, is closed, and the bottom of the bracket 1002, which is located under the reaction part 1003 according to the coupling, is opened. The top surface of the bracket 1002 has an internally-curved shape 1002b at an end thereof.

When the bracket 1002 and the reaction part 1003 are coupled in such a manner, the top surface and inner side surfaces of the bracket 1002 and the top surface of the reaction part 1003 form a reaction chamber structure. That is, the top surface and inner side surfaces of the bracket 1002 and the top surface of the reaction part 1003 form a capillary tube to guarantee rapid sample introduction. The bracket 1002 functions as a protection lid, an air outlet, a space structure layer for a predetermined reaction space, a cover and a vent layer, which are capable of inducing a capillary action to suck a sample.

The internally-curved shape 1002b of the bracket 1002 may promote the capillary action such that a sample introduced from the end of the bracket 1002 is more quickly introduced to the reaction part 1003. The curved shape 1002b also serves to guide with which portion of the reaction part 1001 the user should contact the sample.

The bracket 1002 may be formed of a plastic injection molding material, for example, a transparent PC material such that the user visually checks whether the sample is normally introduced to the reaction part 1003.

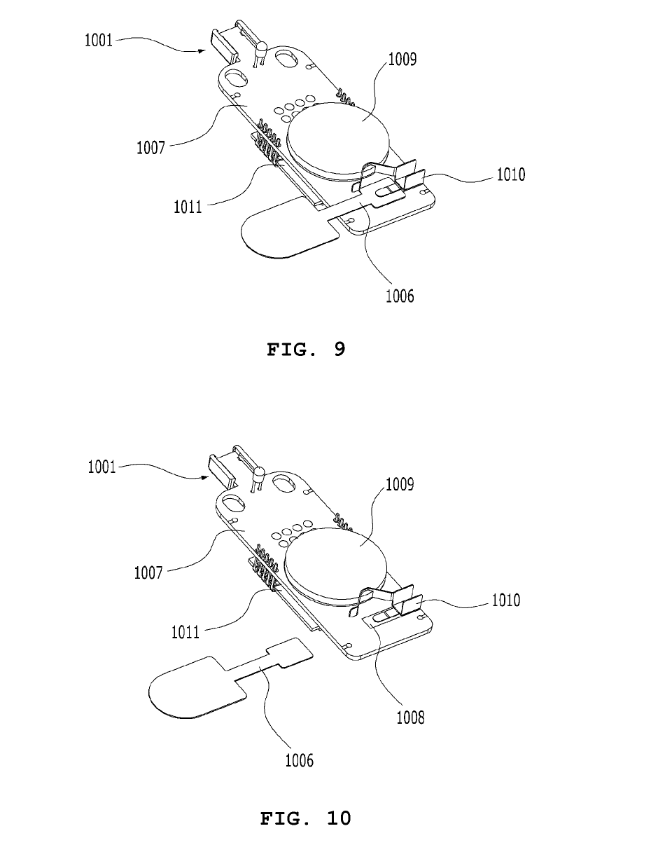

FIG. 9 illustrates a state in which the power supply breaker 1006 is attached before the bio sensing device is used. FIG. 10 illustrates a state in which the power supply breaker 1006 is detached when the bio sensing device is used. Referring to FIG. 9, before the bio sensing device is used, the power supply breaker 1006 is disposed between the main substrate power pin 1008 and the battery terminal 1010 such that the main substrate power pin 1008 and the battery terminal 1010 are not contacted with each other. Therefore, the power supply from the battery 1009 to the main substrate 1007 is disconnected. Referring to FIG. 10, when the power supply breaker 1006 is detached, the main substrate power pin 1008 and the battery terminal 1010 are contacted with each other. Then, power is supplied from the battery 1009 to the main substrate 1007.

The power supply breaker 1006 is formed of a non-conductive flat film to disconnect the electrical connection between the main substrate power pin 1008 and the battery terminal 1010 which are formed of a metal. As such, when the power supply breaker 1006 is formed of a film, it is possible to achieve a cost reduction for the prevention of the battery power waste.

The lancet mounting space 1004 for mounting the lancet 1005 is formed in the right side of the upper and lower housings 1016 and 1017. The upper and lower housings 1016 and 1017 have a groove formed at right ends thereof such that the user may easily attach/detach the lancet 1005.

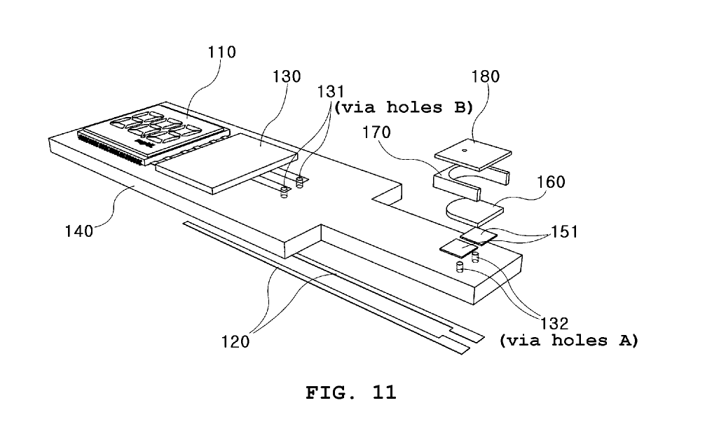

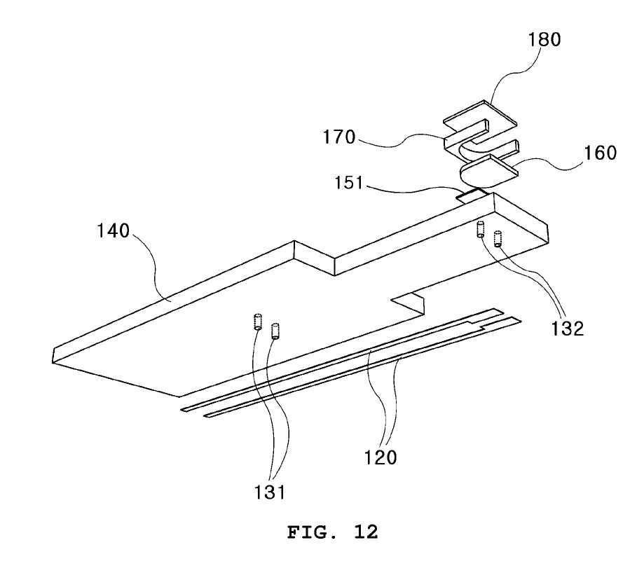

FIGS. 11 to 13 are perspective views of bio sensing devices according to other embodiments of the present invention. FIG. 11 is a top perspective view of a bio sensing device including a reaction part having via holes A 132 formed therein. FIG. 12 is a bottom perspective view of the bio sensing device of FIG. 11. Referring to FIGS. 11 and 12, the bio sensing device according to the embodiment of the present invention includes a screen display part 110, a conducting wire 120, via holes A 132, via holes B 131, a signal processing part 130, an insulator layer 140, a reaction electrode 151, a reaction reagent layer 160, a space layer 170, and a cover 180.

The insulator layer 140 may be formed of any materials as long as they can form a conductive electrode on an insulative substrate. Technologies related to the formation of a conductive electrode on an insulative substrate may include a method in which a conductive electrode is formed by a sputtering process using a shadow mask, a method in which an electrode is formed by a typical sputtering process and formed using a typical photolithography process or laser, and a method in which an electrode is formed using screen printing, electroless plating, or electrolyte plating. For example, the insulator layer 140 may be formed by the following process:

printing electronics are used to form a substrate using various materials such as film, glass, silicon, plastic, fiber and paper, and conductive ink, conductive paste or the like is used to form a pattern. Representative examples of the insulator layer 140 may include a printed circuit board (PBC) which is widely used in the field. Such an insulator layer may be applied the same to other embodiments of the present invention.

The reaction electrode 151, the reaction reagent layer 160, the space layer 170, and the cover 180 constitute a reaction part. The reaction part is where a chemical reaction is caused by a provided material. A reaction chamber is implemented by the reaction reagent layer 160, the space layer 170, and the cover 180. The reaction reagent layer 160 is where a material required for a predetermined reaction of the bio sensing device is disposed.

The space layer 170 surrounds the reaction reagent layer 160. The cover 180 covers the reaction reagent layer 160. A space formed by the space layer 170 and the cover 180 is where a capillary action occurs. The insulator layer 140 serves as a substrate where circuits are arranged.

The reaction electrode 151 serves to generate an electrical signal corresponding to a chemical reaction occurring in the reaction reagent layer. That is, the reaction electrode 151 generates an analogue signal corresponding to an oxidation-reduction reaction caused by a reaction reagent and an analysis target material (for example, blood sugar of blood). The reaction electrode 151 includes a working electrode and a reference electrode. Here, the reaction electrode 151 may include at least two electrodes for electrochemical measurement, and the number of electrodes may be set to three, five, eight or more.

The screen display part 110 serves to display a bio-sensing result. The screen display part 100 serves to inform a user of a measurement result value, and a voice/sound output unit (speaker, buzzer or the like) may be used instead of the screen display part. The screen display part 110 may include an LCD device, an electronic paper, or an LED device.

The signal processing part 130 includes a signal conversion unit, an arithmetic unit, and an output unit. The signal conversion unit is configured to convert an analogue signal, which is generated by the reaction electrode 151 and transmitted through the via holes A 132, the conducting wire 120, and the via holes B 131, into a digital electrical signal. The arithmetic unit is configured to generate a measurement result value of the analysis target material from the digital electrical signal. The output unit is configured to display the generated measurement result value. That is, the signal processing part 130 receives an electrical signal for the reaction result in the reaction reagent layer, provided through the conducting wire 120, and displays a result value corresponding to the electrical signal on the screen display part. The insulator layer 140 is where the conducting layer 120 is formed.

The conducting wire 120 serves to electrically connect the reaction part and the signal processing part, that is, transmit an analogue electrical signal (current or voltage) depending on an electrochemical reaction and an applied voltage between the reaction electrode 151 and the signal processing part 130. The conducting wire 120 serves a signal transmission part in the embodiment of the present invention.

The operation process of the bio sensing device illustrated in FIGS. 11 and 12 will be described as follows. In the following descriptions, a blood sugar measurement of ampero-metry will be taken as an example.

When the signal processing part 130 applies a voltage, the voltage is applied to the reaction electrode 151 through the via holes B 131, the conducting wire 120, and the via holes A 132. As the voltage is applied to the reaction electrode 151, an analogue signal (current) is generated according to an electrochemical reaction between a reaction reagent and an analysis target material (for example, blood sugar of blood) introduced on the reaction reagent. This current is transmitted from the reaction electrode 151 through the via holes A 132, the conducting wire 120, and the via holes B 131 to the signal processing part 130. The signal processing part 130 derives a measurement result value (for example, a blood sugar level corresponding to a concentration of the target analysis material) corresponding to a current through arithmetic processing. The bio sensing device according to this embodiment of the present invention is characterized in that a signal transmission path is formed through the via holes 131 and 132 and thus the conducting wire 120 is disposed under the insulator layer.

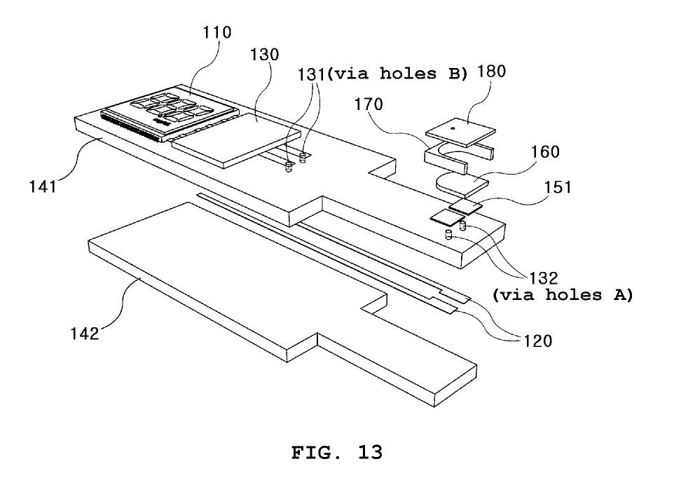

FIG. 13 illustrates a structure having multiple substrates. Referring to FIG. 13, the conducting wire 120 may be formed on a second insulator layer 142, or may be formed under a first insulator layer 141 and covered by the second insulator layer 142.

In the structures illustrated in FIGS. 11 to 13, the via holes B 131 are formed so as not to change the configuration of the signal processing part, but may be modified in various manners. FIGS. 11 to 13 illustrate that the conducting wire is disposed between the signal processing part and the via holes B 131. However, only the via holes may be formed immediately in front of a pin terminal of the signal processing part without the conducting wire, or the pin terminal of the signal processing part may be drawn toward the bottom of the insulator layer without the conducting wire and the via holes B 131 such that the pin terminal and the conducting wire are directly connected to each other.

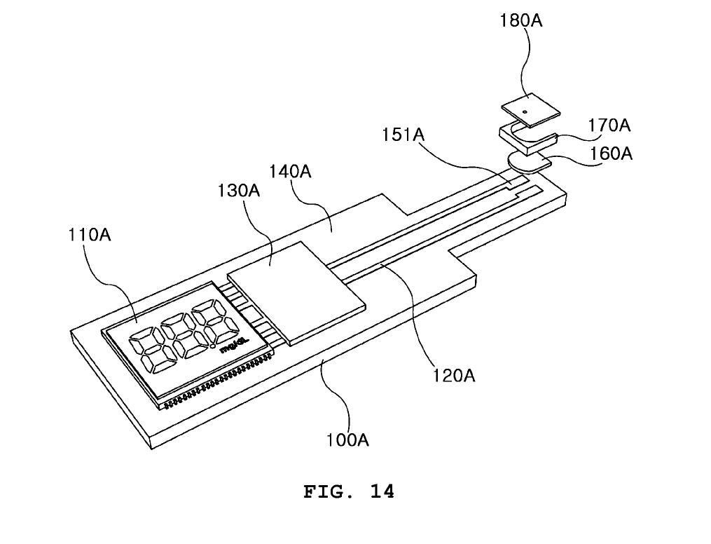

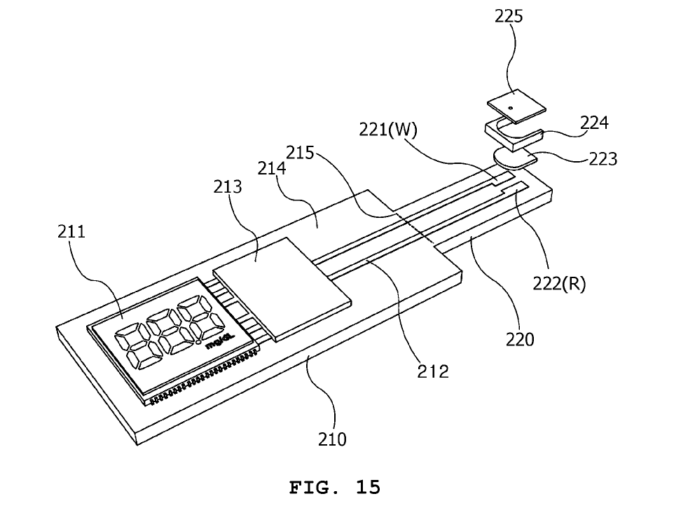

FIG. 14 is a perspective view of a bio sensing device according to another embodiment of the present invention. Referring to FIG. 14, the bio sensing device 100A according to the embodiment of the present invention includes a screen display part 110A, a conducting wire 120A, a signal processing part 130A, an insulator layer 140A, a reaction electrode 151A, a reaction reagent layer 160A, a space layer 170A, and a cover 180A. The screen display part 110A serves to display a bio-sensing result. Here, the reaction electrode 151A, the reaction reagent layer 160A, the space layer 170A, and the cover 180A constitute a reaction part.

The reaction part is where a chemical reaction is caused by a provided material. The reaction reagent layer 160A, the space layer 170A, and the cover 180A form a reaction chamber, and the reaction reagent layer 160A is where a material required for a predetermined reaction operation of the biosensor is disposed. The space layer 170A surrounds the reaction reagent layer 160. The cover 180A covers the reaction reagent layer 160A. A space formed by the spacer layer 170A and the cover 180A is where a capillary action may occur. The reaction electrode 151A is configured to generate an electrical signal corresponding to a chemical reaction occurring in the reaction reagent layer 160. The screen display part 110A may include an LCD device or LED device, and any devices may be used as long as they display information on a screen. In particular, an electronic paper which has been recently developed may be used. The conducting wire 120A serves to electrically connect the reaction electrode 151A and the signal processing part 130A. Here, the reaction electrode 151A and the conducting wire 120A are divided, but may be integrally patterned and formed depending on a manufacturing process of the bio sensing device. The signal processing part 130A is configured to receive an electrical signal for a reaction result in the reaction reagent layer, provided through the conducting wire 120A, and display a result value corresponding to the electrical signal on the screen display part. The insulator layer 140A is where the conducting wire 120A is formed.

In the conventional bio sensing device, the biosensor and the measuring device which are physically separated from each other should be connected to each other through a socket or the like to transmit an analogue electrical signal corresponding to an oxidation-reduction reaction occurring in the biosensor to the measuring device, in order to check the reaction state. During this process, an impedance value of the connection node may act as an obstacle to measuring the value of the analysis target material, thereby degrading the precision. In the bio sensing device according to the embodiment of the present, however, the reaction part and the signal processing part capable of processing the reaction result in the reaction part are formed on one substrate. Therefore, it is possible to exclude an impedance component caused by the connection node such as the socket through which the bio-sensor is physically connected to the measuring device in the conventional bio sensing device. Furthermore, an electrode for detection of sensor insertion and detection of an analysis target material, which has been required in the conventional biosensor, is not necessary in the embodiment of present invention. Therefore, it is possible to exclude an error caused by such an electrode. Furthermore, since contact implement is not formed, a signal generated by an electrochemical reaction in the reaction part may be more sensitively processed inside the bio sensing device. Therefore, the bio sensing device may perform the measurement with more precision. In this embodiment of the present invention, the reaction electrode of the reaction part and the signal processing part are electrically connected through the signal transmission part. Thus, it can be understood that the reaction electrode and the signal transmission part include a conductive material.

Furthermore, the bio sensing device according to the embodiment of the present invention may further include a memory unit (not illustrated) for storing identification information on the bio sensing device. The identification information may be displayed through the screen display part 110 or a display unit which is additionally provided. Here, the identification information may include at least one of the type of an analysis target material, a measurement condition, production information, user information and the like. For example, the bio sensing device may store and display the identification information so as to make it easy to identify for whom the bio sensing device is used among family members.

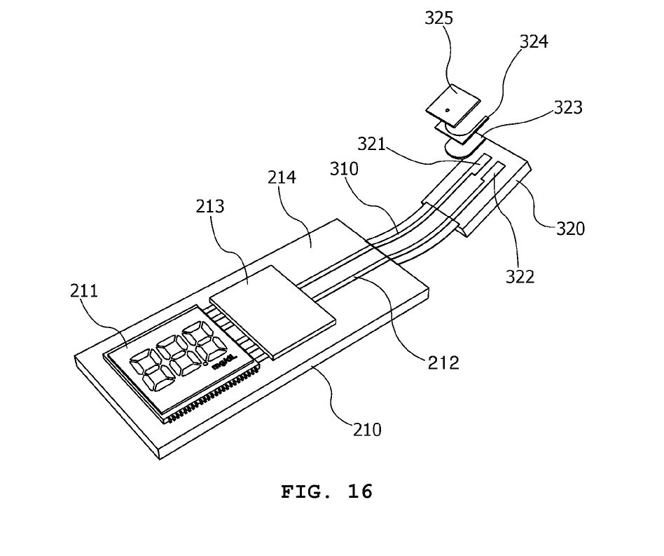

FIGS. 15 to 21 illustrate various embodiments of the bio sensing device according to the present invention. The following descriptions will be focused on specific features of the respective bio sensing devices according to the various embodiments of the present invention, and the bio sensing devices according to the various embodiments of the present invention may selectively include internal components of the above-described bio sensing devices. Furthermore, the respective features according to the various embodiments of the present invention may be combined in various manners so as to form a bio sensing device.

FIG. 15 is a perspective view of a bio sensing device according to another embodiment of the present invention. Referring to FIG. 15, the bio sensing device according to the embodiment of the present invention includes a screen display part 211, a conducting wire 121, a signal processing part 213, an insulator layer 214, reaction electrodes 221 and 222, a reaction reagent layer 223, a space layer 224, and a cover 225.

The bio sensing device according to the embodiment of the present invention includes a first substrate 210 and a second substrate 220. The first substrate 210 may be implemented using the insulator layer illustrated in FIG. 9, and the second substrate 220 may be implemented using a flexible insulator layer including an electrode. The first and second substrates 210 and 220 may be formed of the same material. As a desirable example, the first substrate 210 may be implemented with a PCB or the like, and the second substrate 220 may be implemented with a flexible PCB or the like. The first substrate corresponds to the measuring device according to the embodiments of the present invention, and the second substrate corresponds to the reaction part according to the embodiments of the present invention.

The bio sensing device according to this embodiment of the present invention is characterized in that the first and second substrates 210 and 220 are bonded (refer to reference numeral 215) using a rigid/flexible PCB bonding technology which is widely used in the field. As the two substrates are used, it is possible to improve the reliability of the manufacturing process of the bio sensing device. More specifically, a substrate where the reaction reagent having a large effect on precision and reproducibility of a bio-sensing result is disposed may be separately manufactured, and a substrate where the signal processing part including electronic parts is disposed may be separately manufactured. Then, the two substrates may be bonded to thereby improve the reliability of the manufacturing process.

FIG. 16 is a perspective view of a bio sensing device according to another embodiment of the present invention. Referring to FIG. 16, the bio sensing device according to the embodiment of the present invention includes a screen display part 211, a conducting wire 212, a signal processing part 213, an insulator layer 214, reaction electrodes 321 and 322, a reaction reagent layer 323, a space layer 324, and a cover 325. The bio sensing device according to this embodiment of the present invention is characterized in that it includes first and second substrates 210 and 320 connected through a heat seal 310.

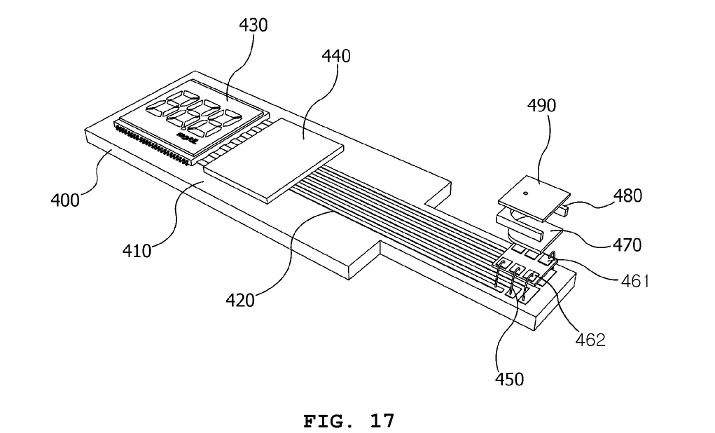

FIG. 17 is a perspective view of a bio sensing device according to another embodiment of the present invention. Referring to FIG. 17, the bio sensing device 400 according to the embodiment of the present invention includes a screen display part 430, a conducting wire 420, a signal processing part 440, an insulator layer 410, reaction electrodes 461 and 462, a reaction reagent layer 470, a space layer 480, and a cover 490. The bio sensing device according to this embodiment of the present invention is characterized in that the reaction electrodes 461 and 462 are connected to the conducting wire 420 through wire bonding 450.

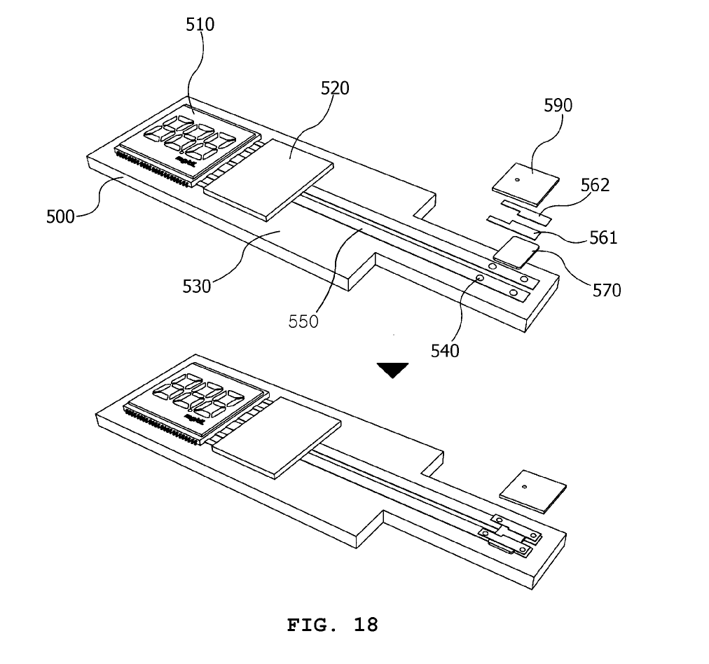

FIG. 18 is a perspective view of a bio sensing device according to another embodiment of the present invention. Referring to FIG. 18, the bio sensing device according to the embodiment of the present invention includes a screen display part 510, a conducting wire 550, a signal processing part 520, an insulator layer 530, reaction electrodes 561 and 562, a reaction reagent layer 570, and a cover 590. The bio sensing device according to this embodiment of the present invention is characterized in that the reaction electrodes 561 and 562 are connected to the conducting wire 550 through a conductive bump 540.

As the conductive bump 540 is used, a capillary tube space is formed between the conductive bump 540 and the reaction electrodes 561 and 562. Therefore, a space layer and a vent hole are not separately required. For example, since the reaction reagent layer 570 is connected to the conductive bump 540, a separate vent hole is not necessary. Furthermore, when the conductive bump 540 is constructed in various shapes, the reaction reagent layer 570 may be inclined in such a manner as to introduce a sample more smoothly. Furthermore, as the conductive bump 540 is used, only an area which genuinely reacts may be efficiently made into the reaction reagent layer, which makes it possible to expect cost reduction and yield improvement. FIG. 18 illustrates in the bottom that the conductive bump, the reaction electrode, and the reaction reagent layer are assembled.

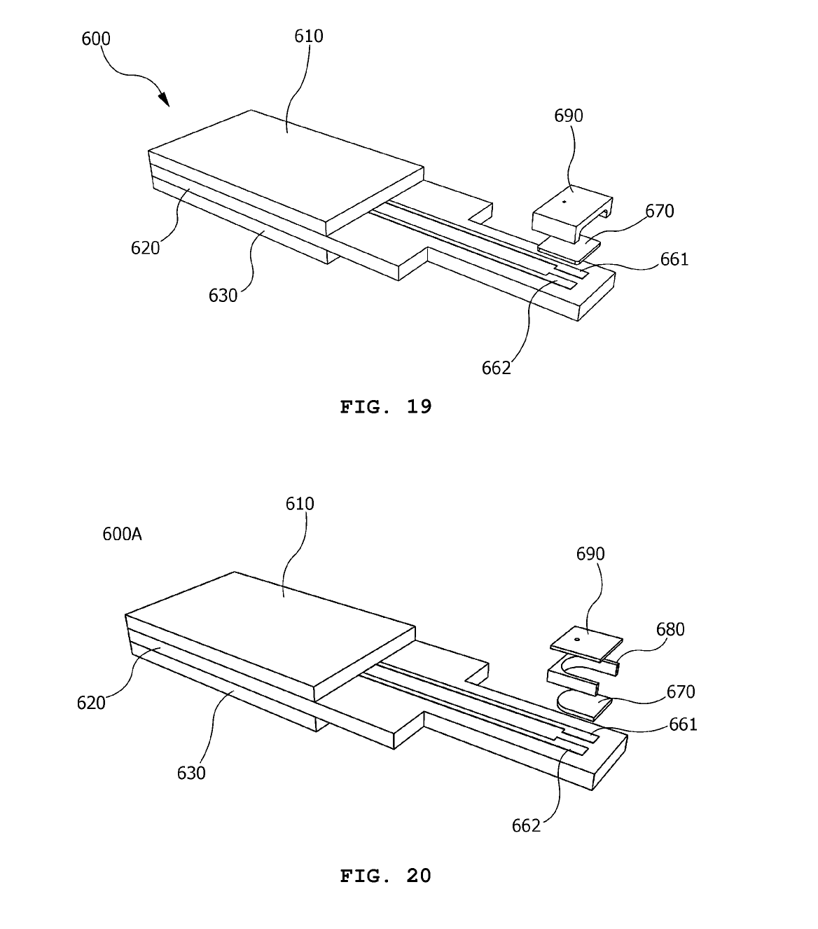

FIG. 19 is a perspective view of a bio sensing device according to another embodiment of the present invention. Referring to FIG. 19, the bio sensing device according to the embodiment of the present invention includes a first substrate 610, a second substrate 620, a third substrate 630, reaction electrodes 661 and 662, a reaction reagent layer 670, and a cover 690. The bio sensing device according to this embodiment of the present invention is characterized in that it includes the plurality of substrates, and the respective substrates 610, 620, and 630 may be used as insulator layers. An interconnection necessary for the bio sensing device may be formed in any one of the substrates 610, 620, and 630, or may be partially formed in the respective substrates 610, 620, and 630. FIG. 19 does not illustrate other necessary parts, in order to emphasize that the bio sensing device uses the plurality of substrates. However, the bio sensing device may include various parts required for the above-described operation of the bio sensing device.

FIG. 20 is a perspective view of a bio sensing device according to another embodiment of the present invention. Referring to FIG. 20, the bio sensing device 600A according to the embodiment of the present invention includes a first substrate 610, a second substrate 620, a third substrate 630, reaction electrodes 661 and 662, a reaction reagent layer 670, a space layer 680, and a cover 690. The bio sensing device according to this embodiment of the present invention is characterized in that it includes the plurality of electrodes, and the respective substrates 610, 620, and 630 may be used as insulator layers. That is, an interconnection necessary for the bio sensing device may be formed in any one of the substrates 610, 620, and 630, or may be partially formed in the respective substrates 610, 620, and 630. Furthermore, the bio sensing device according to the embodiment of the present invention includes the space layer 680 unlike the bio sensing device illustrated in FIG. 19. In the bio sensing device of FIG. 19, the cover 690 has a dome structure to function as the space layer. Therefore, the bio sensing device of FIG. 19 does not need to be provided with a space layer. Such a cover structure may be applied to the other embodiments of the present invention.

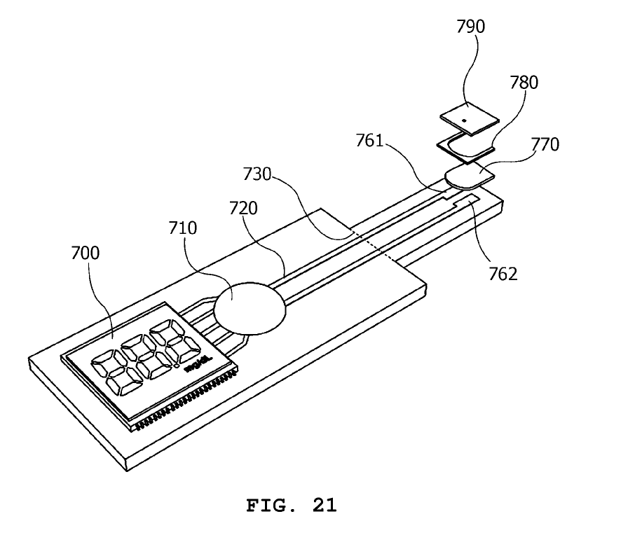

FIG. 21 is a perspective view of a bio sensing device according to another embodiment of the present invention. Referring to FIG. 21, the bio sensing device according to the embodiment of the present invention includes a screen display part 700, an integrated circuit (IC) 710, a conducting wire 720, reaction electrodes 761 and 762, a reaction reagent layer 770, a space layer 780, and a cover 790. In the bio sensing device according to the embodiment of the present invention, the IC 710 includes a signal processing part with active and passive elements, and is configured to contain a variety of information such as code information in the elements. That is, a separate memory unit for storing information is not additionally formed in the bio sensing device, and the IC 710 is implemented by containing code information in the signal processing part. For example, the IC 710 may be implemented with one IC chip which is typically called SoC (System on Chip).

Meanwhile, the configuration of the bio sensing device according to the embodiment of the present invention may be applied to the other embodiments of the present invention. Furthermore, as in the bio sensing device of FIG. 15, two substrates may be bonded (refer to reference numeral 730) using a rigid/flexible PCB bonding technology.

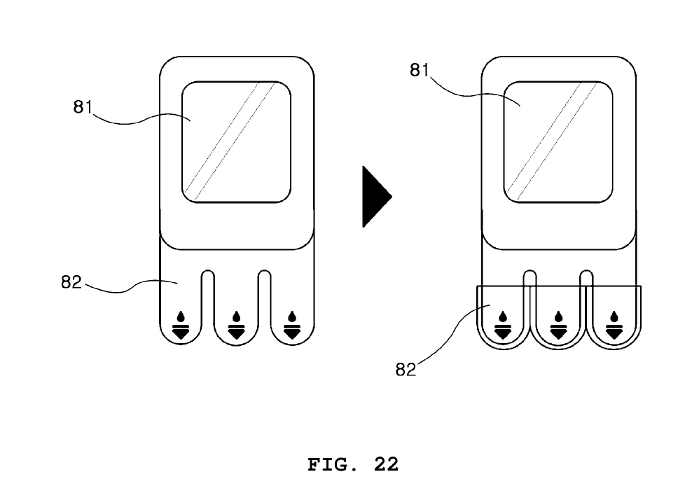

Hereafter, bio sensing devices including a plurality of reaction parts to perform various types of bio-sensing operations will be described with reference to FIGS. 22 to 24.

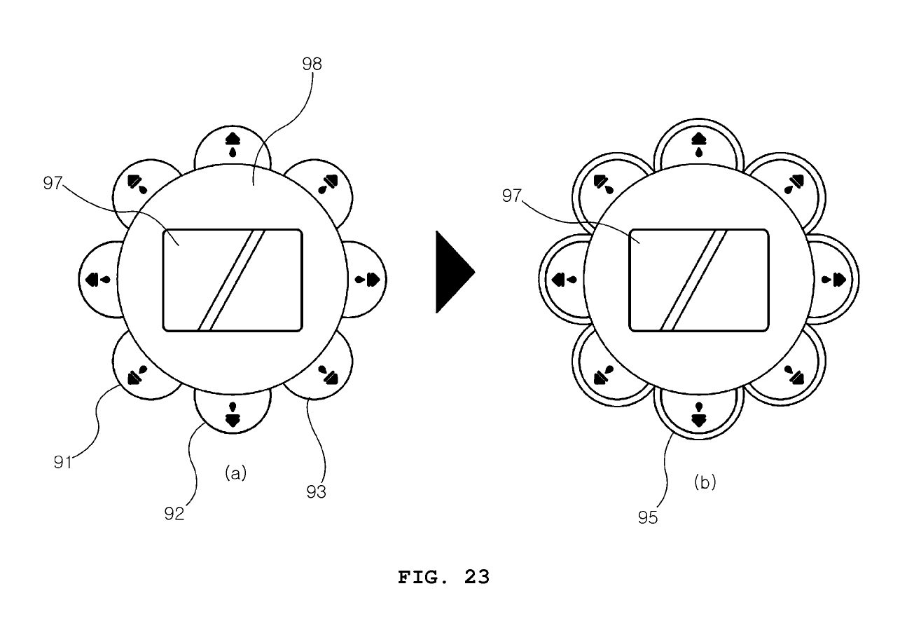

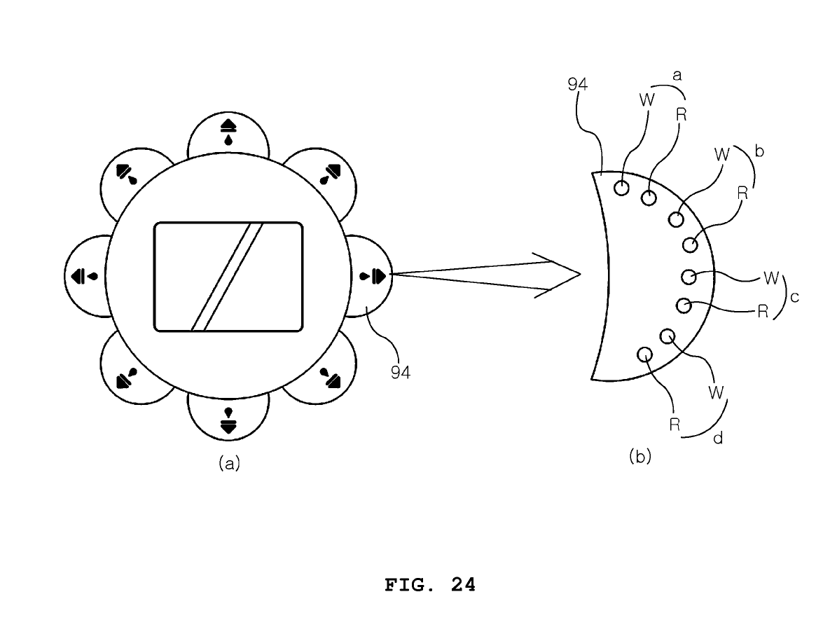

FIG. 22 is a perspective view of a bio sensing device including a plurality of reaction parts according to another embodiment of the present invention. FIG. 23 is a perspective view of a bio sensing device including a plurality of reaction parts according to another embodiment of the present invention. FIG. 24 is a perspective view of a bio sensing device including a plurality of reaction parts according to another embodiment of the present invention.

Referring to FIGS. 22 and 23, when the bio sensing device includes one screen display part (refer to reference numeral 81 of FIG. 22 or reference numeral 97 of FIG. 23) and a plurality of reaction parts provided in a signal processing part, the bio sensing device may perform various bio-sensing operations. Each of the reaction parts (refer to reference numeral 82 of FIG. 22 or reference numerals 91, 92, and 93 of FIG. 23) includes reaction electrodes and a material for bio-sensing. Furthermore, the reaction part includes a plurality of conducting wires (signal transmission parts) for transmitting an electrical signal from the reaction electrodes to the signal processing part provided therein, and the number of the conducting wires corresponds to the number of the reaction parts.

The material for bio-sensing is provided in a reaction chamber disposed in the reaction part, and the reaction chamber may be applied according to the above-described various embodiments of the present invention. In particular, one substrate may be used, or a first substrate (refer to reference numeral 98 of FIG. 23) and a plurality of second substrates (refer to reference numerals 91, 92, and 93 of FIG. 23) may be used. When one substrate is used, the reaction parts illustrated in FIGS. 9, 17, 18, 19, and 20 may be applied. When the first substrate and the second substrates are used, the reaction parts illustrated in FIGS. 15, 16, and 21 may be applied. Here, the substrate where the reaction part is located is referred to as an auxiliary substrate, and the substrate where the signal processing part is located is referred to as a main substrate.

Furthermore, when the bio sensing device is constructed as illustrated in FIG. 22, the plurality of reaction parts may be arranged only in one side, and when the bio sensing device is constructed as illustrated in FIG. 23, the plurality of reaction parts (refer to reference numerals 91, 92, and 93) may be arranged in all directions. Furthermore, since the material for a chemical reaction is disposed in the reaction parts, the bio sensing device may further include a package for packaging the respective reaction parts (refer to reference numeral 95 of FIG. 23) to perform a dampproof function. The bio sensing devices according to the above-described embodiments of the present invention may also include the package for a dampproof function, which has been described with reference to FIG. 23. Furthermore, the screen display part may include an LCD device, an LED device, or all kinds of display devices capable of displaying information. Furthermore, referring to FIG. 24, each reaction part 94 may include a pair of reaction electrode and chemical material, the reaction electrode having two or more electrodes (refer to a, b, c, and d). In this case, the reaction part may perform different kinds of bio-sensing operations.

In the above-described embodiments of the present invention, the detailed descriptions of additional components such as a power supply unit and a button were omitted, but a power supply unit (for example, battery, USB connection or the like) and a small number of input units (for example, key button, LCD screen menu and the like) may be further provided.

One or more of the features included in the above-described various embodiments of the present invention may be selected and combined to implement a bio sensing device, if necessary.

The above-described bio sensing devices according to the embodiments of the present invention may be applied to implement a bio sensing device capable of measuring blood sugar, glycosylated hemoglobin (HbAlc), and hemoglobin (Hb) which need to be measured together.

While the present invention has been described with respect to the specific embodiments, it will be apparent to those skilled in the art that various changes and modifications may be made without departing from the spirit and scope of the invention as defined in the following claims.

What is claimed is:

1. A bio sensing device comprising:
a main substrate;
a reaction part comprising a reaction reagent to react in an oxidation-reduction reaction with an analysis target material and a reaction electrode to generate an analogue electrical signal by causing the oxidation-reduction reaction, and located at an end of the main substrate;
a signal processing part located on a first side of the main substrate and processing the analogue electrical signal;
a screen display part displaying a processing result of the signal processing part; and
a housing to house the main substrate,
wherein the screen display part is three-dimensionally disposed over the signal processing part, and a space for mounting a lancet is formed in the housing.

2. The bio sensing device according to claim 1, wherein the mounting space for the lancet in the housing is formed opposite to the end of the main substrate.

3. The bio sensing device according to claim 1, wherein the screen display part is disposed on a second substrate located over the signal processing part.

4. The bio sensing device according to claim 1, further comprising a bracket coupled to the end of the main substrate and forming a capillary tube into the reaction part.

5. The bio sensing device according to claim 4, wherein the main substrate and the bracket are coupled by grooves and protrusions.

6. The bio sensing device according to claim 4, wherein the bracket has a closed top and an opened bottom.

7. The bio sensing device according to claim 4, wherein the top of the bracket has an internally-curved shape at an end thereof.

8. The bio sensing device according to claim 4, wherein the bracket comprises a transparent plastic material.

9. The bio sensing device according to claim 1, further comprising a battery to supply power to the signal processing part,
wherein the battery comprises a battery terminal,
a power pin electrically-connected to the battery terminal is formed on at least one side of the main substrate; and
a power supply breaker is disposed between the power pin and the battery terminal so as to temporarily disconnect the electrical connection therebetween.

10. The bio sensing device according to claim 9, wherein the power supply breaker comprises a non-conductive flat film.

11. The bio sensing device according to claim 1, wherein the reaction part and the signal processing part are disposed on one substrate.

12. The bio sensing device according to claim 1, wherein the reaction part and the signal processing part are disposed on different substrates, and electrically connected by substrate bonding or heat seal.

13. A bio sensing device comprising:
a main substrate having a protruding end;
a reaction part comprising a reaction reagent to react in an oxygen-reduction reaction with an analysis target material and a reaction electrode to generate an analogue electrical signal by causing the oxygen-reduction reaction, and located at the end of the main substrate;
a signal processing part located on a first side of the main substrate and processing the analogue electrical signal;
a screen display part displaying a processing result of the signal processing part,
wherein the screen display part is disposed on a second side of the main substrate and opposite to the first side, and
a space for mounting a lancet is formed opposite to the end of the main substrate.
